(19) United States
(12) Patent Application Publication
(10) Pub. No.: US 2017/0344492 A1
(43) Pub. Date: Nov. 30, 2017

(54) ADDRESS TRANSLATION WITHIN A VIRTUALISED SYSTEM BACKGROUND

(71) Applicant: ARM Limited, Cambridge (GB)

(72) Inventors: Guillaume BOLBENES, Antibes (FR); Jean-Paul Georges PONCELET, Antibes (FR)

(21) Appl. No.: 15/592,529

(22) Filed: May 11, 2017

(30) Foreign Application Priority Data
May 26, 2016 (GB) 1609276.9

(51) Int. Cl. G06F 12/1027; G06F 12/1009

(52) U.S. Cl. CPC G06F 12/1027; G06F 12/1009; G06F 2212/684; G06F 2212/657

(57) ABSTRACT

A memory management unit 22, 34, 48 serves to use first stage of address translation and permission data S1 managed by a guest operating system and second stage of address translation and permission data S2 managed by a hypervisor. If there is a mismatch between the permissions (or other characteristics) provided by these different translation and permission data sets, then a speculative mismatch response is triggered. This speculative mismatch response may comprise storing a virtual address to intermediate physical address mapping within a cache 32, 36 within the memory management unit. Such a cache can subsequently be accessed by an instruction seeking to determine an intermediate physical address associated with a mismatch without having to wait for a full translation (page table walk) operation to be performed.

### BACKGROUND

### Technical Field

This disclosure relates to the field of data processing systems. More particularly, this disclosure relates to address translation within a virtualized system.

### Technical Background

It is known to provide virtualized data processing systems in which a virtual address generated by a guest operating system is translated to a physical address of a memory system together with the determination of one or more associated memory permissions (and characteristics). Such a translation and permission determination process may be performed in accordance with a first stage of address translation and permission data managed by a guest operating system and a second stage of address translation and permission data managed by a hypervisor. The two stages of address translation and permission data supporting virtualization allow the guest operating system to operate as if it were alone and the hypervisor to manage memory translation and permissions at a higher level in order, for example, to support the presence of multiple guest operating systems, to enforce higher levels of security, or for some other reason. However, the provision of two stages of address translation and permission data has the result that when both stages of this address translation and permission data need to be accessed, such as via a page table walk, relatively long processing delays can result.

### SUMMARY

At least some embodiments of the present disclosure provide apparatus for processing data comprising:

address translation circuitry to translate a virtual address of a memory access generated by a guest operating system to a physical address of a memory system and to determine one or more associated memory permissions in accordance with a first stage of address translation and permission data managed by said guest operating system and a second stage of address translation and permission data managed by a hypervisor;

mismatch detecting circuitry to detect a mismatch between said first stage of address translation and permission data and said second stage of address translation and permission data; and

speculative mismatch response provision circuitry responsive to detection of said mismatch to trigger a speculative mismatch response provision operation to provide speculative mismatch response for use in handling said mismatch.

At least some embodiments of the present disclosure provide apparatus for processing data comprising:

address translation means for translating a virtual address of a memory access generated by a guest operating system to a physical address of a memory system and for determining one or more associated memory permissions in accordance with a first stage of address translation and permission data managed by said guest operating system and a second stage of address translation and permission data managed by a hypervisor;

mismatch detecting means for detecting a mismatch between said first stage of address translation and permission data and said second stage of address translation and permission data; and

speculative mismatch response provision means responsive to detection of said mismatch for triggering a speculative mismatch response provision operation to provide speculative mismatch response for use in handling said mismatch.

At least some embodiments of the present disclosure provide a method of processing data comprising:

in accordance with a first stage of address translation and permission data managed by a guest operating system and a second stage of address translation and permission data managed by a hypervisor, translating a virtual address of a memory access generated by said guest operating system to a physical address of a memory system and determining one or more associated memory permissions;

detecting a mismatch between said first stage of address translation and permission data and said second stage of address translation and permission data; and

in response to detection of said mismatch, triggering a speculative mismatch response provision operation to provide speculative mismatch response for use in handling said mismatch.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates a page table walk using a first stage of address translation and permission data in combination with a second stage of address translation and permission data;

FIG. 2 schematically illustrates a an example embodiment of a memory management unit for controlling memory address translations and memory access permissions;

FIG. 3 schematically illustrates a variety of different potential mismatches between first stage address translation and permission data and second stage address translation and permission data;

FIG. 4 schematically illustrates a further example embodiment of a memory management unit; and

FIG. 5 schematically illustrates a further example embodiment of a memory management unit.

### DESCRIPTION OF EXAMPLES

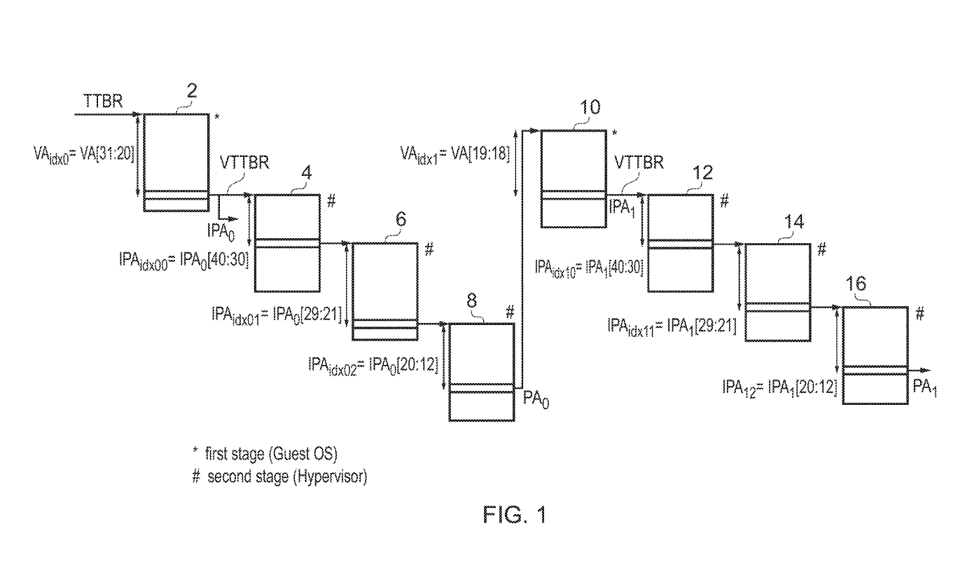

FIG. 1 schematically illustrates translation of a virtual address VA of a memory access generated by a guest operating system to a physical address PA of a memory system, and the determination of one or more associated access permissions in accordance with a first stage of address translation and permission data managed by the guest operating system and a second stage of address translation and permission data managed by a hypervisor. In particular, when a memory access request requires translation via a page table walk, such as, as a result of a miss within a translation lookaside buffer, then a translation table base register value TTBR is referenced (TTBR may be set in a configuration register) to indicate the starting location of a first translation table for the first stage of address translation permission data as managed by a guest operating system. In this example embodiment, a 32-bit virtual address VA is translated into a 48-bit physical address PA. For example, the 32-bit address may be an AARCH32 address and the 48-bit address may be an AARCH64 address using a 4 kB memory page granularity in accordance with the memory architectures provided by ARM Limited of Cambridge, England.

The first translation within the first translation (page) table 2 uses the high order bits VA [31:20] of the input virtual address as an index to generate a first intermediate physical address IPA₀. Virtualized translation table base register VTTBR stored within a configuration register of the system provides a pointer to the start address of the first translation (page) table 4 within the second stage of address translation and permission data managed by the hypervisor. Successive portions of the first intermediate physical address IPA₀ are then used as indexes into this first translation table 4 and subsequent translation tables 6, 8 of the second stage of address translation and permission data in order to generate a first portion of the physical address translation PA₀. This first portion of the physical address PA₀ provides a pointer to a second translation table 10 within the first stage of address translation and the permission data managed by the guest operating system. A lower significant portion of the input virtual address, namely VA [19:12], is then used as an index into this second page 10 of the first stage of address translation admission data. This generates a second intermediate physical address IPA₁. The virtual translation table base register and the second intermediate physical address IPA₁ are then used to perform a second Phase of page table walking through page tables 12, 14, 16 of the second stage of address translation and permission data as managed by the hypervisor in order to generate the second portion of the physical address PA₁. In this way, a virtual address VA of a memory access generated by the guest operating system is translated via an intermediate physical address IPA to form a physical address PA.

As well as performing the address translation, the first stage of address translation and permission data also yields permissions and other characteristics associated with a memory address as specified and managed by the guest operating system. Similarly, the second stage of address translation and permission data yields permissions and other characteristics for that same memory access as managed by the hypervisor. It will be appreciated that mismatches may arise between the characteristics of a memory access specified within the first stage of address translation and permission data as managed by the guest operating system and those permissions and other characteristics specified for the same memory access within the second stage of address translation and permission data as managed by the hypervisor. When such mismatches arise, an exception handling routine may be triggered to operate under control of the hypervisor in order to resolve the mismatch, such as by updating the second stage of address translation and permission data as specified by the hypervisor, or by triggering an appropriate security response if it appears that a memory access which is being attempted by a guest operating system, and which is permitted by the permissions and other characteristics of that guest operating system, is one which the hypervisor using its own permissions and other characteristics indicate should not be permitted. The hypervisor when responding to such a mismatch may need to examine and modify the contents of the both the first stage of address translation permission data and the second stage of address translation and permission data. In order to access the appropriate portions of this data, the hypervisor may need to determine at least some of the intermediate physical addresses IPAs which were generated during a corresponding address translation in order that the appropriate entries within the tables 2 to 16 can be examined, and if necessary modified. However, the intermediate physical address will typically be a parameter which is dynamically determined within page table walking circuitry of a memory management unit and is not normally available to the hypervisor program. In order to address this, the data processing system may be provided with an intermediate physical address lookup instruction ATS1E1 which when issued to a memory management unit will cause that memory management unit to return address translation and permission data associated with the first stage (S1) of address translation and permission data when executing at exception level E1, but without performing all of the second stage of address translation and permission data generation (e.g. it performs steps 2, 4, 6, 8 and 10, but not steps 12, 14 and 16). Thus, the hypervisor may be returned (e.g. by storing the IPA within a predetermined special purpose register) one or more of the intermediate physical addresses IPAs in order that these may then be used by appropriate mismatch (fault) handling software executed under control of the hypervisor to perform an appropriate response. The memory management unit responds to the intermediate physical address lookup instruction ATS1E1 by returning at least the second-stage intermediate physical address (and any other data required by the architecture to respond to the ATS1E1 instruction).

It will be appreciated that the mismatch between the first stage of address translation and permission data and the second stage of address translation and permission data could take a variety of different forms. However, one particular situation which can arise is where the mismatch concerned relates to a second-stage permission restriction for a second-stage-restricted memory access. This is a memory access that is subject to a virtual address via intermediate physical address to physical address translation and is one in which a second-stage permission restriction arises. Such a second-stage permission restriction may arise when the second-stage restricted memory access is one which is indicated as a non-restricted access (e.g. permitted) by the first stage of address translation and permission data and is indicated as a restricted access (e.g. not permitted) by the second stage of address translation and permission data. As an example, the memory access received may be a write access. The first stage of address translation and permission data may indicate that such a write access is permitted to the address concerned. However, the second stage of address translation and permission data may indicate that only read access is permitted for that memory access (given the level of privilege, or other characteristics associated with that memory access) and accordingly, is more restrictive. Such a situation need not necessarily indicate inappropriate security threatening behavior of the system, and may rather indicate that some corrective action is needed to the hypervisor to modify the second stage of address translation and permission data to take account of the requirements of the memory access received from the guest operating system. In either case, the hypervisor program in such an example may need to determine the intermediate physical addresses IPAs which were used in performing the translation and permission determination for the received memory access in order that the relevant translation table entries may be read and modified, or confirmed, as necessary. As previous mentioned, the hypervisor program can issue an address translation instruction ATS1E1 to a memory management unit to return the intermediate physical address. However, the page table walking operations associated with determining the intermediate physical address in response to such an address translation instruction are relatively slow and can accordingly reduce overall system performance. Thus, it may be desirable if mechanisms may be provided that are able to permit the hypervisor to obtain a response to its address translation instruction (intermediate physical address look up instruction (ATS1E1)) more rapidly.

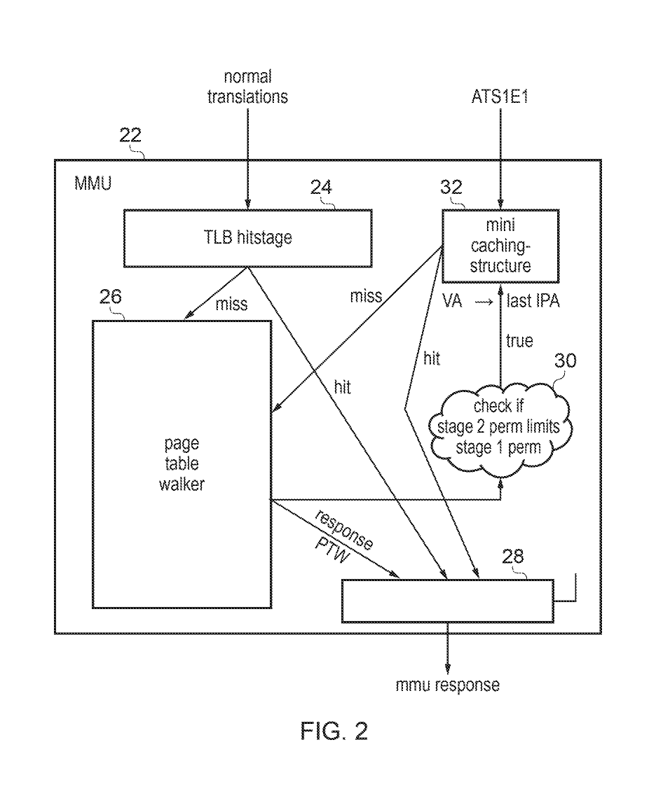

FIG. 2 schematically illustrates a memory management unit 22 including a translation lookaside buffer 24. A memory access request resulting in a normal translation request is received by the memory management unit 22 at the translation lookaside buffer 24. If there is a miss in the translation lookaside buffer 24, then a page table walk operation as illustrated in FIG. 1 is performed by page table walking circuitry 26. A response from this page table walking operation is then supplied to a response output register 28 from where the memory management unit response is returned from the memory management unit 22, namely the appropriate physical address and the associated permissions and other characteristics.

As part of the page table walk operation performed by the page table walking circuitry 26, the memory access permissions and other characteristics associated with both the first stage of address translation permission data and the second stage of address translation and permission data are supplied to mismatch detecting circuitry 30. This mismatch detecting circuitry 30 also serves as second-stage permission restriction detecting circuitry as in this example embodiment it serves to detect instances where the second stage of address translation and permission data is more restrictive than the first stage of address translation and permission data. If the second-stage permission restriction detecting circuitry 30 determines that the second stage of address translation and permission data is more restrictive than the first stage of address translation and permission data, then it serves to store the available intermediate physical address data IPA and virtual address VA for the page table walk which has just been performed (and accordingly is still available within the page table walking circuitry 26) into a second-stage-restricted cache memory 32. This provides a virtual address to intermediate physical address mapping that can be accessed using the virtual address. The storing of this virtual address to intermediate physical address mapping constitutes a speculative mismatch response provision operation (more specifically a speculative translation provision operation) which can subsequently be utilized to service an intermediate address lookup instruction received by the memory management unit 22. The mismatch detecting circuitry 30 and the cache 32 accordingly serve as speculative mismatch response provision circuitry (speculative translation provision circuitry) and are responsive to detection of a second-stage permission restriction to trigger a speculative translation provision operation which provides speculative second-stage-restricted data mapping a virtual address VA associated with the second-stage-restricted memory access (the one for which the restriction condition has been detected) to a second-stage intermediate physical address(es) IPA associated with that second-stage-restricted memory access.

The cache 32 may be relatively small and yet store a plurality of entries mapping a virtual address to a last intermediate physical address IPA₁. This cache 32 may then be accessed when an intermediate physical address lookup instruction is received and accordingly will serve as intermediate physical address lookup circuitry. If a hit occurs within the cache 32 in response to such an intermediate physical address lookup operation, then the desired intermediate physical address may is returned. The virtual address to intermediate physical address mapping stored within the cache 32 serves as speculative second-stage-restricted data which is stored when the memory management unit 22 itself determines that there is a mismatch in the permission data using the mismatch detecting circuitry 30. Such speculative stored mapping data (speculative second-stage-restricted data) is then used to service any intermediate physical address lookup instructions for which the virtual address VA matches the virtual address stored within that speculative second-stage-restricted data within the cache 32.

If when the cache 32 receives an intermediate address lookup instruction (ATS1E1) and there is a miss, then a page table walking operation is triggered to be performed by the page table walking circuitry 26 and the process illustrated in FIG. 1 is performed in order to generate the intermediate physical address IPA₁ to be returned back to the hypervisor. Such a page table walking response will also be checked by the mismatch detecting circuitry 30 and cached within the cache 32 if it corresponds to a mismatch of a type being monitored.

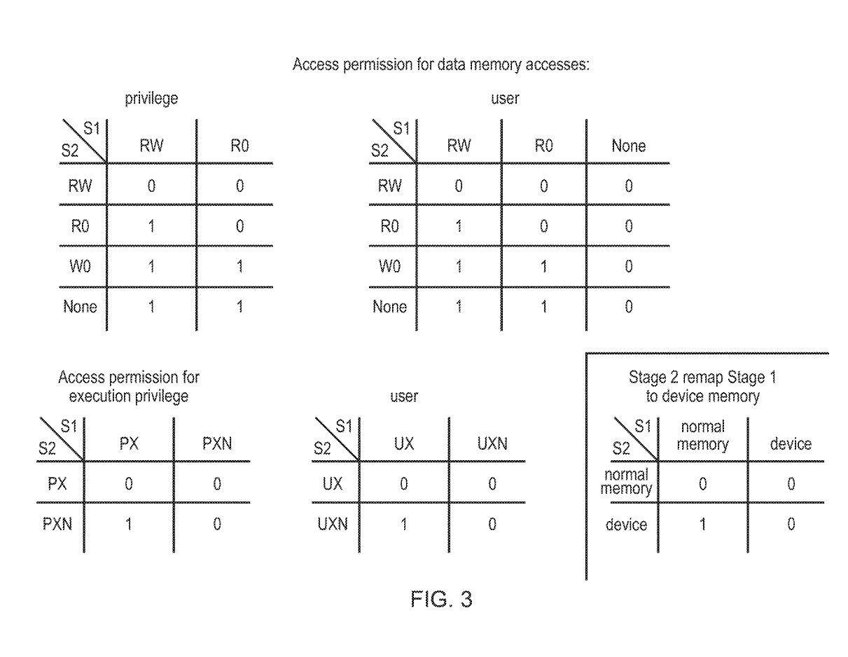

FIG. 3 schematically illustrates a number of tables illustrating possible mismatches (restrictions) which can arise between first stage address translation and permission data S1 and second stage translation and permission data S2. The top two tables illustrate respectively for both privileged mode of operation and user mode of operation, which combinations of read write RW, read only RO, write only WO and no access as specified by the various stages of address translation and permission data constitute mismatches (inappropriate restrictions). In the case of FIG. 3 those combinations where there is a restriction imposed by the second stage of address translation and permission data which is not imposed by the first stage of address translation and permission data are indicated by a “1” in the table concerned. Considering, for example, the upper left table shown in FIG. 3, when the first stage of address translation and permission data indicates that read and write permission is available, RW, then if the second stage of the address translation and permission data is anything other than also indicating that read write permission is available, then a mismatch (second stage restriction) is present. Thus, as shown in this table, a mismatch (restriction by the second stage) arises when the second stage permission data is any of read only RO, write only WO or none.

FIG. 3 also illustrates the relationship between access permissions for execution granted by the first stage of address translation and permission data and the second stage of address translation and permission data for both privilege mode (PX, PXN) and user mode (UX, UXN). Consider the user mode of operation where the first stage of address translation and permission data S1 indicates that a memory access corresponds to user mode executable UX. In this case, if the second stage of address translation permission data S2 indicates user mode not executable UXN, then this constitutes a restriction by the second stage of a address translation and permission data and this is indicated by an “1” in the table.

Finally, FIG. 3 illustrates a potential mismatch (restriction) which can arise between the first stage of address translation and permission data S1 and the second stage of address translation and permission data S2 when the characteristic of whether a memory location is normal memory or device memory is concerned. If the second stage of address translation and permission data S2 specifies that a memory access corresponds to device memory, then this is more restrictive than if the first stage of address translation and permission data S1 indicates that the same memory access corresponds to normal memory. This is indicated by a “1” in this final table.

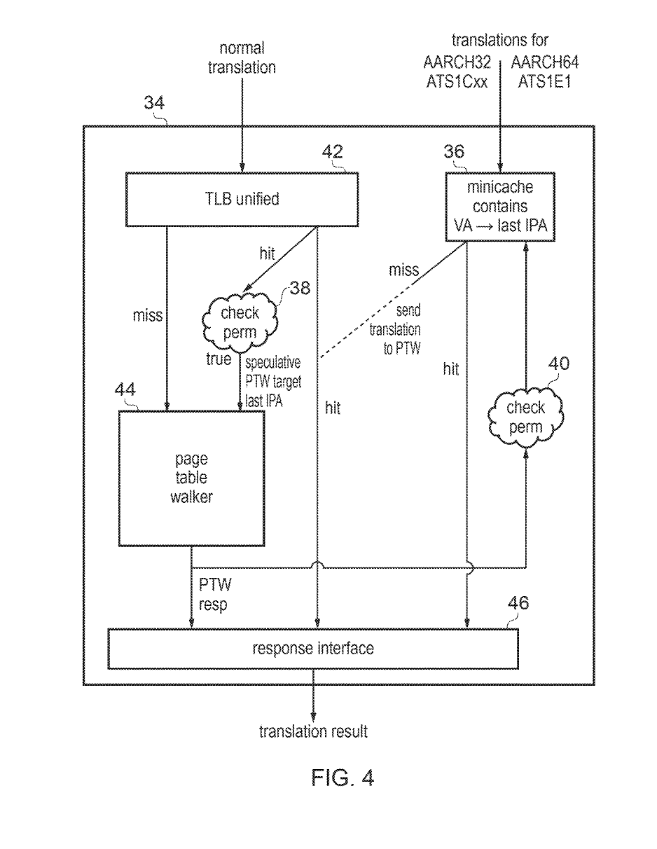

FIG. 4 illustrates a further example memory management unit 34. In this example, a cache 36 is provided to store virtual address to last intermediate physical address IPA mappings as speculative second-stage-restricted data. Allocation of entries into the cache 36 are triggered by detection of one of the restrictions illustrated by a “1” in FIG. 3. The circuitry 38, 40 which performs the checks illustrated in FIG. 3 is indicated by the function “check permission” in FIG. 4. In the case of a normal translation lookup received at a translation lookaside buffer 42 of the memory management unit 34, when a translation lookaside buffer miss occurs, a page table walk is performed by a page table walking circuit 44. This performs a two-phase page table walking operation as illustrated in FIG. 1. When the page table walk response is returned from the page table walking circuitry 44, this written into the translation lookaside buffer 42 and is checked by the check permission circuitry 40, If the second stage of permission data limits the first stage of permission data, then an allocation is made into the cache 36 to store a virtual address to last intermediate physical address mapping. The response interface 46 returns the result of the page table walking operation to the entity which requested the lookup in the translation lookaside buffer 42. When this translation is subsequently actioned, if it results in a permission fault, then fault handling by a hypervisor program will be triggered and this can result in the hypervisor program issuing an intermediate physical address lookup instruction (ATS1E1) in order to return the last intermediate physical address (such as writing this into an appropriate response register, e.g. PAR_EL2). As a consequence of the check permission circuitry 40 having stored the virtual address to last intermediate physical address mapping within the cache 36, this intermediate address lookup instruction (ATS1E1) will hit within the cache 36 using its virtual address and the cache 36 can rapidly write the correct intermediate physical address value into the response register PAR_EL2.

In the case of a hit within the translation lookaside buffer 42 in response to a received normal translation request, then this results in the return of a translation response by the response interface 46 as before. The hit response is also checked by check permission circuitry 38. If the check performed by the check permission circuitry 38 indicates at the second stage of address translation permission data is more restrictive than the first stage of address translation and permission data, then a speculative page table walk operation is initiated and performed by the page table walking circuitry 44 in order to obtain the last intermediate physical address associated with that translation. This last intermediate physical address IPA is then stored together with the virtual address to which it corresponds into the cache 36. Accordingly, if the response returned from a response interface 46 initiates a permission fault resulting in the hypervisor generating an intermediate address lookup instruction ATS1E1, then this may again be serviced from the cache 36 without waiting for a further page table walk to be performed. Thus, in the case of the circuitry of FIG. 4, the speculative translation provision operation triggered by the permission circuitry 38 is the initialization of a further address translation of the virtual address by the page table walking circuitry 44 in order to generate the virtual address to last intermediate physical address mapping.

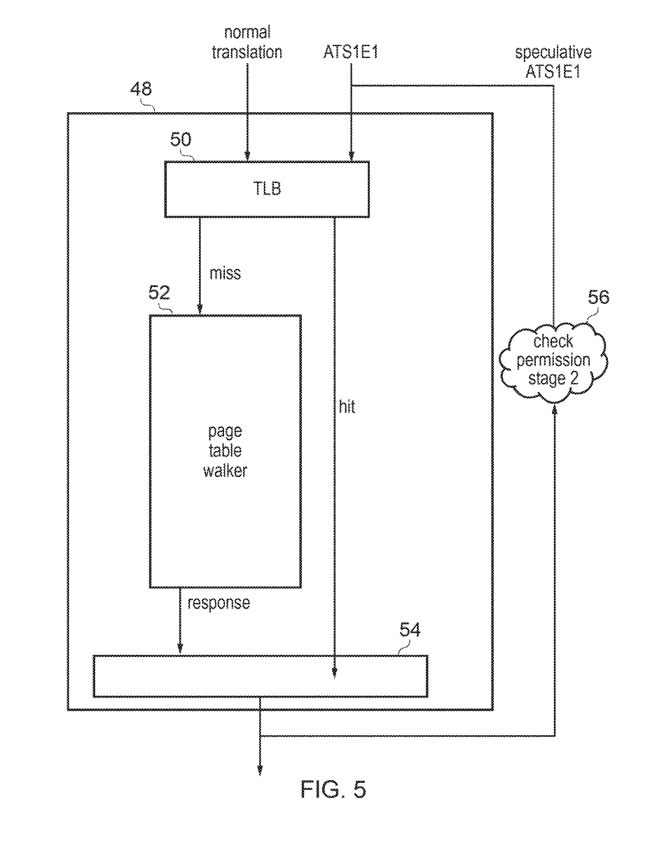

FIG. 5 schematically illustrates another example embodiment of a memory management unit 48. This memory management unit 48 includes a translation lookaside buffer 50, page table walking circuitry 52 and a response interface 54. In this example embodiment, check permission circuitry 56 is provided to monitor all the translation responses returned from the response interface 54 to determine if any of these correspond to a mismatch as illustrated in the examples of FIG. 3. If such a mismatch (stage two restriction) is detected, then the check permission circuitry 56 serves to itself generate a speculative intermediate address lookup instruction ATS1E1 which is issued to the memory management unit 48. This speculative intermediate address lookup instruction triggers a page table walk using the page table walking circuitry 52 and results in the last intermediate physical address IPA being returned into the response register PAR_EL2. This speculatively generated response can then be read by an intermediate address look up instruction ATS1E1 generated by a hypervisor program. In this example, the response register or circuitry associated therewith may also serve to track the virtual address to which that response corresponds in order that an intermediate address lookup instruction has issued by a hypervisor program can be properly matched with a speculative intermediate address lookup instruction for which the result is already held within the result register PAR_EL2.

It will be appreciated that in the example of FIG. 1, a translation between a virtual address VA and a physical address PA is performed via an intermediate physical address IPA. If may also be the case that some memory management units 22, 34, 48 it may be possible to store and handle translations/mapping data which accommodates both direct mappings from virtual addresses to physical addresses and mappings between virtual addresses and intermediate physical addresses. In the case that the translation lookaside buffer stores a direct mapping between the virtual address and the physical address, this can give rise to a need to access the intermediate physical address which was generated during the translation in order that a permission or other mismatch may be addressed and accordingly such situations are ones in which the present techniques may, for example, be used.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data comprising:
address translation circuitry to translate a virtual address of a memory access generated by a guest operating system to a physical address of a memory system and to determine one or more associated memory permissions in accordance with a first stage of address translation and permission data managed by said guest operating system and a second stage of address translation and permission data managed by a hypervisor;
mismatch detecting circuitry to detect a mismatch between said first stage of address translation and permission data and said second stage of address translation and permission data; and
speculative mismatch response provision circuitry responsive to detection of said mismatch to trigger a speculative mismatch response provision operation to provide speculative mismatch response for use in handling said mismatch.

2. Apparatus as claimed in claim 1, wherein
said address translation circuitry translates said virtual address via an intermediate physical address to said physical address and;
said mismatch detecting circuitry is second-stage permission restriction detecting circuitry to detect a second-stage permission restriction when a second-stage-restricted memory access is indicated as a permitted access by said first stage of address translation and permission data and is indicated as a restricted access by said second stage of address translation and permission data; and
said speculative mismatch response provision circuitry is speculative translation provision circuitry responsive to detection of said second-stage permission restriction to trigger a speculative translation provision operation to provide speculative second-stage-restricted data mapping a virtual address associated with said second-stage-restricted memory access to a second-stage intermediate physical address associated with said second-stage-restricted memory access.

3. Apparatus as claimed in claim 2, comprising intermediate physical address lookup circuitry responsive to an intermediate physical address lookup instruction for a target virtual address to determine if said target virtual address matches said virtual address of said second-stage-restricted memory access and, if so, to use said speculative second-stage-restricted data to return at least said second-stage intermediate physical address.

4. Apparatus as claimed in claim 2, comprising a second-stage-restricted cache memory and said speculative translation provision operation comprises storing said speculative second-stage-restricted data in said second-stage-restricted cache memory in response to said detection of said second-stage permission restriction.

5. Apparatus as claimed in claim 4, wherein said speculative second-stage-restricted cache memory comprises storage for a plurality of instances of said speculative second-stage-restricted data corresponding to different virtual addresses.

6. Apparatus as claimed in claim 3, wherein said intermediate physical address lookup circuitry performs a lookup using said target virtual address within said second-stage-restricted cache memory in response to said intermediate physical address lookup instruction.

7. Apparatus as claimed in claim 6, wherein, if said lookup misses in said second-stage-restricted cache, then said intermediate physical address lookup circuitry triggers said address translation circuitry to use said first stage of translation and permission data and said second stage of translation and permission data to generate said second-stage intermediate physical address.

8. Apparatus as claimed in claim 3, wherein said speculative translation provision operation comprises initiating a further translation by said address translation circuitry of said virtual address of said second-stage-restricted memory access to generate said speculative second-stage-restricted data mapping to said second-stage intermediate physical address.

9. Apparatus as claimed in claim 8, wherein said further translation speculatively performs operations corresponding to said intermediate address lookup instruction and said intermediate physical address lookup circuitry is responsive to a match between said target virtual address and said virtual address of said second-stage-restricted memory access to use a result of said further translation as a result of said said intermediate address lookup instruction.

10. Apparatus as claimed in claim 1, wherein said first stage translation and permission data comprises first stage page table data managed by said guest operating system and said second stage translation and permission data comprises second stage page table data managed by said hypervisor.

11. Apparatus as claimed in claim 10, wherein said address translation circuitry translates to generate said physical address and determines said associated memory permissions using a plurality of page table walking operations accessing both said first stage page table data and said second stage page table data.

12. Apparatus as claimed in claim 2, comprising a translation lookaside buffer to store translation and permission data dependent upon both said first stage of translation and permission data and said second stage of translation and permission data, wherein said second-stage permission restriction detecting circuitry triggers said speculative translation provision operation upon detection of writing of an entry into said said translation lookaside buffer with permission attributes corresponding to said permitted access by said first stage translation and permission data and said restricted access by said second stage translation and permission data.

13. Apparatus as claimed in claim 12, wherein at least some of said translation and permission data stored in said translation lookaside buffer directly maps virtual addresses to physical addresses.

14. Apparatus as claimed in claim 12, wherein at least some of said translation and permission data stored in said translation lookaside buffer maps virtual addresses to intermediate physical addresses

15. Apparatus as claimed in claim 2, wherein said second-stage permission restriction corresponds to at least one of:
said second stage translation and permission data indicating more restrictive read or write permissions for said memory access than said said second stage translation and permission data;
said second stage translation and permission data indicating more restrictive execution permissions for said memory access than said said second stage translation and permission data; and
said second stage translation and permission data indicating more restrictive device memory characteristics for said memory access than said said second stage translation and permission data;

16. Apparatus as claimed in claim 1, wherein said apparatus for processing data is a memory management unit.

17. Apparatus for processing data comprising:
address translation means for translating a virtual address of a memory access generated by a guest operating system to a physical address of a memory system and for determining one or more associated memory permissions in accordance with a first stage of address translation and permission data managed by said guest operating system and a second stage of address translation and permission data managed by a hypervisor;
mismatch detecting means for detecting a mismatch between said first stage of address translation and permission data and said second stage of address translation and permission data; and
speculative mismatch response provision means responsive to detection of said mismatch for triggering a speculative mismatch response provision operation to provide speculative mismatch response for use in handling said mismatch.

18. A method of processing data comprising:
in accordance with a first stage of address translation and permission data managed by a guest operating system and a second stage of address translation and permission data managed by a hypervisor, translating a virtual address of a memory access generated by said guest operating system to a physical address of a memory system and determining one or more associated memory permissions;
detecting a mismatch between said first stage of address translation and permission data and said second stage of address translation and permission data; and
in response to detection of said mismatch, triggering a speculative mismatch response provision operation to provide speculative mismatch response for use in handling said mismatch.
